(19) United States
(12) Patent Application Publication
(10) Pub. No.: US 2026/0367862 A1
(43) Pub. Date: Nov. 19, 2026

(54) AUDIO SHARING DEVICE AND SYSTEM

(71) Applicant: Magic Control Technology Corporation, New Taipei City (TW)

(72) Inventor: Pei-Chung LIU, New Taipei City (TW)

(21) Appl. No.: 19/377,533

(22) Filed: Nov. 3, 2025

(30) Foreign Application Priority Data
May 19, 2025 (TW) 114118727

(51) Int. Cl. G06F 3/16

(52) U.S. Cl. CPC G06F 3/162

(57) ABSTRACT

The present invention includes an audio sharing device, comprising: a sharing port for receiving and transmitting audio signals; a controlling portion connected to the sharing port, the controlling portion comprises a USB audio controller for converting and transmitting between audio signals and USB signals; an audio processing module connected to the controlling portion and comprising processing units for processing audio signals; a wireless module connected to the audio processing module for receiving and transmitting audio signals; an audio input/output module connected to the audio processing module for playing and receiving audio signals; and a microprocessor connected to the audio processing module, the audio input/output module and the wireless module for controlling the audio processing module to process an audio signal sharing.

### BACKGROUND OF THE INVENTION

### 1. Field of the Invention

The present invention relates to an audio sharing device and system.

### 2. The Prior Art

When multiple terminals (e.g. cellphones, tablets, computing devices, etc.) are sharing audio signals between them, if a complex and high-cost server network is employed, the audio signal sharing may be performed only through a server, resulting in difficulty in the sharing process.

In addition, in order to connect terminals such as cellphones, tablets, computing devices to other apparatuses, data ports such as earphone ports, USB-C ports, or USB-A ports are provided on the existing terminals. However, since the number of the data ports of the terminals is limited, the number of apparatuses connected to terminals is limited.

Therefore, it is urgently required to provide a technical solution to share audio signals between multiple terminals (e.g. cellphones, tablets, computing devices, etc.) more effectively.

### SUMMARY OF THE INVENTION

To solve the aforementioned problem effectively, the present invention provides an audio sharing device, comprising: a sharing port for receiving and transmitting audio signals; a controlling portion connected to the sharing port, the controlling portion comprises a USB audio controller for converting and transmitting between audio signals and USB signals; an audio processing module connected to the controlling portion, comprising a plurality of processing units for processing audio signals; a wireless module connected to the audio processing module for wirelessly receiving and transmitting audio signals; an audio input/output module connected to the audio processing module for playing and receiving audio signals; and a microprocessor connected to the audio processing module, the audio input/output module and the wireless module for controlling the audio processing module to process an audio signal sharing of the audio sharing device.

According to an embodiment of the present invention, the sharing port is connected to a first electronic device to receive audio signals from the first electronic device and transmit audio signals to the first electronic device, the sharing port is wirelessly connected to a second electronic device to receive audio signals from the second electronic device and transmit audio signals to the second electronic device, and the audio input/output module is connected to an audio input/output device to receive audio signals from the audio input/output device and transmit audio signals to the audio input/output device.

According to an embodiment of the present invention, the audio processing module comprises: a first processing unit for receiving audio signals from the second electronic device via the wireless module and audio signals from the audio input/output device via the audio input/output module, and processing the audio signals to form a first channel audio signal; a second processing unit for receiving audio signals from the first electronic device via the controlling portion and audio signals from the audio input/output device via the audio input/output module, and processing the audio signals to form a second channel audio signal; and a third processing unit for receiving audio signals from the first electronic device via the controlling portion and audio signals from the second electronic device via the wireless module, and processing the audio signals to form a third channel audio signal.

According to an embodiment of the present invention, the first channel audio signal is transmitted to the first electronic device by the controlling portion and the sharing port, wherein the second channel audio signal is transmitted to the second electronic device by the wireless module, and wherein the third channel audio signal is transmitted to the audio input/output device by the audio input/output module.

According to an embodiment of the present invention, the audio sharing device further comprises: a power supply port for receiving power from a power source; a power unit connected to the controlling portion and the sharing port for controlling the received power; a USB connection port connected to the controlling portion for connecting to a USB device; a memory card connection port connected to the controlling portion for writing audio signals into a memory card; a network connection port connected to the controlling portion for connecting to network; and a multifunctional controller in the controlling portion for controlling a hub function of the audio sharing device.

To solve the aforementioned problem effectively, the present invention provides an audio sharing system, comprising: the aforementioned audio sharing device; and an electronic device, comprising: a processor for performing an application; a memory for storing audio signals; a storage unit for storing the application; and a wireless module for wirelessly connecting the audio sharing device to receive audio signals from the audio sharing device, the application performs an AI processing to audio signals by using the processor or on the cloud.

According to an embodiment of the present invention, the AI processing comprises real-time AI functionalities such as real-time audio-to-text conversion, real-time audio translation, real-time speaker recognition, and non-real-time AI functionalities such as audio summary, audio translation.

According to an embodiment of the present invention, the audio sharing device further comprises a button unit, the button unit is connected to the microprocessor to control the mode-switching of the audio sharing system.

According to an embodiment of the present invention, controlling the audio sharing system comprises: a wireless mode allowing the wireless module to be connected to the electronic device in a manner that enable the electronic device to make a voice call; and an AI mode allowing the wireless module to be connected to the electronic device in a manner that enable the electronic device to record voices such that the application performs the AI audio processing by using the processor or on the cloud.

Through the audio sharing device and system, the audio signals may be shared between multiple terminals (e.g. cellphones, tablets, computing devices, etc.) more effectively.

### BRIEF DESCRIPTION OF THE DRAWINGS

FIG. 1 is a block diagram of an audio sharing device according to a first embodiment of the present invention;

FIG. 2 is a block diagram of the audio sharing device according to a second embodiment of the present invention;

FIG. 3 is a schematic view of a first application scenario of the audio sharing device according to the first embodiment of the present invention;

FIG. 4 is a schematic view of a second application scenario of the audio sharing device according to the first embodiment of the present invention;

FIG. 5 is a block diagram of an audio sharing system according to the embodiments of the present invention; and

FIG. 6 is a schematic view of an application scenario of the audio sharing system according to the embodiments of the present invention.

### DETAILED DESCRIPTION OF THE PREFERRED EMBODIMENT

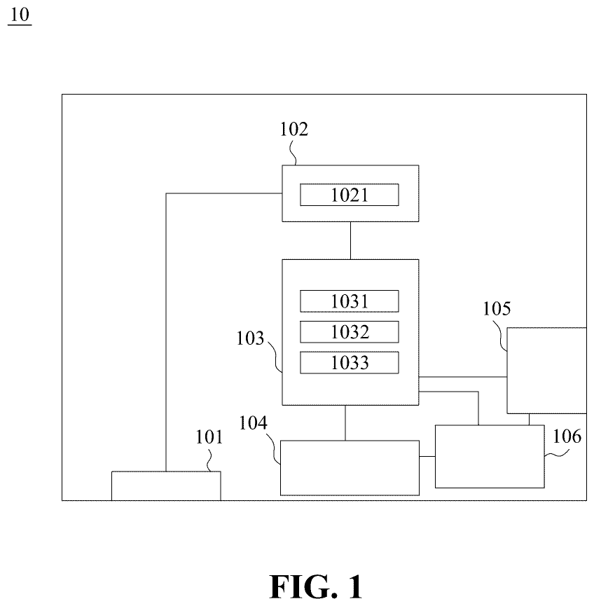

Referring to FIG. 1, FIG. 1 is a block diagram of an audio sharing device 10 according to a first embodiment of the present invention.

As shown in FIG. 1, the audio sharing device 10 comprises: a sharing port 101 connected to a first electronic device to receive and transmit audio signals, and receive power; a controlling portion 102 comprising a USB audio controller 1021 for the conversion and transmission between audio signals and USB signals; an audio processing module 103 comprising a plurality of processing units 1031, 1032, and 1033 for processing audio signals; a wireless module 104 for wirelessly receiving and transmitting audio signals; an audio input/output module 105 for playing and receiving audio signals; and a microprocessor 106 for controlling the audio processing module 103 to process an audio signal sharing between the first electronic device, a second electronic device, and the audio input/output module 105, wherein the first electronic device and the second electronic device are connected to the audio sharing device 10. Here, the wireless module 104 may be wirelessly connected to the second electronic device.

It should be understood that in the first embodiment, the microprocessor 106 is for controlling the audio processing module 103 to process the audio signal sharing between the first electronic device, the second electronic device, and the audio input/output module 105, wherein the first electronic device and the second electronic device are connected to the audio sharing device 10. That is, through the microprocessor 106, each of the first electronic device, the second electronic device and the audio input/output module 105 may simultaneously receive all of the other audio signals transmitted to the audio sharing device 10.

Here, both the first electronic device and the second electronic device may be implemented as devices such as cellphones, computers, tablets, etc. The distinction between the first electronic device and the second electronic device is merely the manner of connection. Specifically, the manner of connection of the first electronic device is by physical connection through the sharing port 101. For example, the sharing port 101 may be implemented as a USB-C connection port, but the present invention is not limited thereto, it may also be a USB-A connection port, a DisplayPort connection port, a HDMI connection port, etc. Specifically, the manner of connection of the second electronic device is by wireless connection through the wireless module 104. For example, the manner of wireless connection may be through Wi-Fi, Bluetooth, etc.

Hereinafter, the functions of each elements of the audio sharing device 10, and the receiving and transmitting of audio signals will be described in more details.

Specifically, the USB audio controller 1021 is configured to convert and transmit between audio signals and USB signals. For example, the USB audio controller 1021 converts the audio signals outputted by the audio processing module 103 into to USB Audio Class (UAC) form, so as to transmit it to the sharing port 101, or signals having UAC or other forms received by the sharing port 101 are converted to audio signals, so as to transmit it to the audio processing module 103 to perform an audio processing.

Specifically, the audio processing of the audio processing module 103 comprises various audio signal processing such as echo cancellation, noise cancellation, gain adjustment, audio mixing, etc. In addition, the audio processing module 103 comprises: a first processing unit 1031 for receiving audio signals from a second channel and a third channel to perform various audio signal processing to transmit a first channel audio signal to a first channel; a second processing unit 1032 for receiving audio signals from the first channel and the third channel to perform various audio signal processing to transmit a second channel audio signal to the second channel; and a third processing unit 1033 for receiving audio signals from the first channel and the second channel to perform various audio signal processing to transmit a third channel audio signal to the third channel.

Specifically, the audio input/output module 105 is for playing and receiving audio signals. It should be understood that the audio sharing device 10 may have the functionalities of playing and receiving audio signals itself, for example, it is provided with a microphone and a speaker. Alternatively, the audio sharing device 10 may be connected to an audio input/output device having the functionalities of playing and receiving audio signals, i.e., the audio input/output device provided with a microphone and a speaker, for example, an earphone having a microphone function. Alternatively, the audio input/output device may have the functionality of wireless connection, allowing the audio input/output device to wirelessly connect through the wireless module 104.

Subsequently, the three receiving and transmitting channels of the audio sharing device 10 will be specifically described.

The first channel: the audio sharing device 10 receives audio signals from the first electronic device connected through the sharing port 101, and transmits audio signals through the sharing port 101 to the first electronic device.

Here, when receiving audio signals, audio signals are transmitted through the sharing port 101 from the first electronic device to the USB audio controller 1021 of the controlling portion 102 so as to perform an audio form conversion. Next, the USB audio controller 1021 transmits audio signals to the second processing unit 1032 and the third processing unit 1033 of the audio processing module 103 to process audio signals.

Here, when transmitting audio signals, audio signals are transmitted to the first processing unit 1031 of the audio processing module 103, the first processing unit 1031 outputs the first channel audio signal, and the first channel audio signal is transmitted from the first processing unit 1031 of the audio processing module 103 to the USB audio controller 1021 of the controlling portion 102. Next, the USB audio controller 1021 converts the audio form of the first channel audio signal. Finally, the form-converted first channel audio signal is transmitted to the first electronic device by the sharing port 101.

The second channel: the second electronic device connected through the wireless module 104 receives and transmits audio signals.

Here, when receiving audio signals, audio signals are transmitted through the wireless module 104 to the first processing unit 1031 and the third processing unit 1033 of the audio processing module 103 so as to process audio signals.

Here, when transmitting audio signals, audio signals are transmitted to the second processing unit 1032 of the audio processing module 103, the second processing unit 1032 outputs the second channel audio signal, and the second channel audio signal is transmitted from the second processing unit 1032 of the audio processing module 103 to the wireless module 104. Finally, through the wireless module 104, it is wirelessly transmitted to the second electronic device.

The third channel: audio signals are received from the audio input/output module 105.

Here, when receiving audio signals, audio signals are transmitted from the audio input/output module 105 to the first processing unit 1031 and the third processing unit 1032 of the audio processing module 103, or transmitted through the audio input/output module 105 from the audio input/output device to the first processing unit 1031 and the third processing unit 1032 of the audio processing module 103 so as to process audio signals. When the audio input/output device is wirelessly connected through the wireless module 104, audio signals are firstly transmitted from the wireless module 104 to the audio input/output module 105.

Here, when transmitting audio signals, audio signals are transmitted to the third processing unit 1033 of the audio processing module 103, the third processing unit 1033 outputs the third channel audio signal, and the third channel audio signal is transmitted from the third processing unit 1033 of the audio processing module 103 to the audio input/output module 105, transmitted through the audio input/output module 105 to the audio input/output device, or transmitted through the audio input/output module 105 then through the wireless module 104 to the audio input/output device.

It should be understood that the aforementioned channels are merely used to describe the receiving and transmitting of audio signals, and according to different using modes of a user, the audio signals may be received and transmitted using different channels. Specifically, the audio sharing device of the present invention is for sharing audio signals. Therefore, the audio signals received from the first channel may be outputted by the second channel and/or the third channel, the audio signals received from the second channel may be outputted by the first channel and/or the third channel, and the audio signals received from the third channel may be outputted by the first channel and/or the second channel. In addition, when a plurality of audio signals is required to be outputted from a single channel, the processing of audio signals by the audio processing module 103 comprises perform audio mixing on the plurality of audio signals.

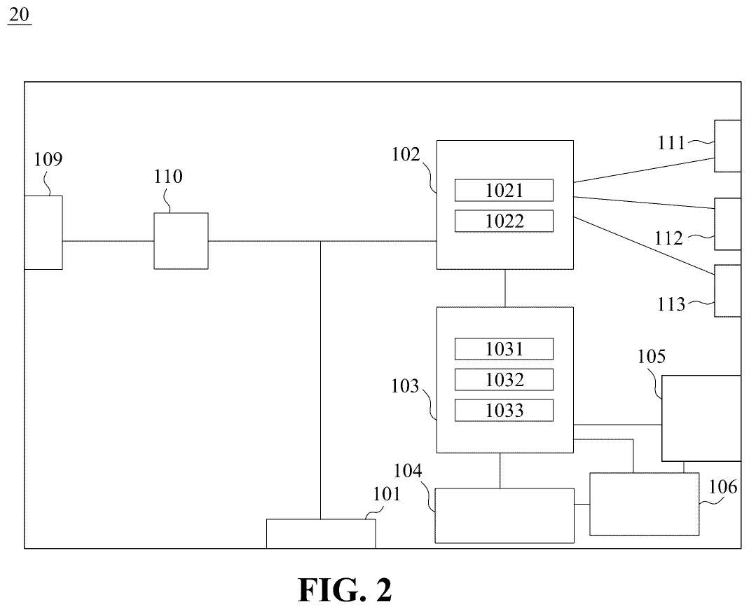

Referring to FIG. 2, FIG. 2 is a block diagram of the audio sharing device 20 according to a second embodiment of the present invention.

As shown in FIG. 2, the audio sharing device 20 comprises: a sharing port 101 connected to a first electronic device to receive and transmit audio signals, and receive power; a controlling portion 102 comprising a USB audio controller 1021, and a multifunctional controller 1022 for converting and transmitting between audio signals and USB signals and controlling a hub function; an audio processing module 103 comprising a plurality of processing units 1031, 1032, and 1033 for processing audio signals; a wireless module 104 wirelessly receiving and transmitting audio signals; an audio input/output module 105 for playing and receiving audio signals; and a microprocessor 106 for controlling the audio processing module 103 to process the audio signal sharing between the first electronic device, a second electronic device, and the audio input/output module 105, wherein the first electronic device and the second electronic device are connected to the audio sharing device 20; a power supply port 109 for receiving power from a power source, for example, a socket or a power bank; a power unit 110 for controlling the received power; a USB connection port 111 for connecting to a USB device; a memory card connection port 112 for writing audio signals into a memory card; and an internet connection port 113 for connecting to internet. Here, it is understandable that in the second embodiment, in addition to the inherent function of audio sharing of the audio sharing device 10, the audio sharing device 20 further has a hub function.

It should be noted that the present invention is not limited to the aforementioned embodiments, in other embodiments, the number of the sharing ports and the USB connection ports may increase as needed, the embodiment is by way of example only, not for limiting the present invention.

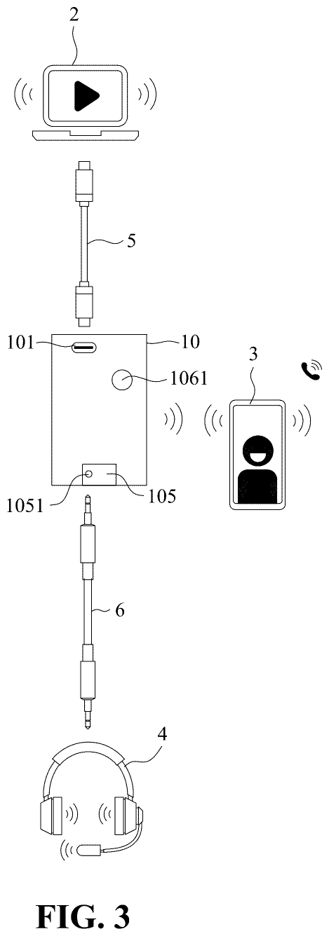

Referring to FIG. 3, FIG. 3 is a schematic view of a first application scenario of the audio sharing device 10 according to the first embodiment of the present invention. As shown in FIG. 3, in terms of the externals of the audio sharing device 10, the audio sharing device 10 is connected to a computing device 2 through the video connection cable 5, connected to a mobile device 3 through wireless communication, and connected to the audio input/output device 4 through the audio connection cable 6. In the first application scenario, the video connection cable 5 may be a USB-C cable to allow the computing device 2 to be connected to the audio sharing device 10 through the sharing port 101. The audio connection cable 6 may be a general 3.5 mm audio cable, and the audio input/output module 105 may include an audio cable port 1051 to allow the audio input/output device 4 to be connected to the audio sharing device 10 through the audio connection cable 6. In addition, the audio sharing device 10 may comprise a button unit 1061, the button unit 1061 is connected to the microprocessor 106 to allow a user to control the mode-switching of the audio sharing device 10 by the button unit 1061.

In the first application scenario, the computing device 2 may be a laptop, the mobile device 3 may be a cellphone or a tablet, the audio input/output device may be a headset 4, the audio sharing device 10 enables the computing device 2, the mobile device 3, and the audio input/output device 4 to be connected at the same time to share and transmit audio signals mutually. Specifically, the microprocessor 106 controls the audio processing module 103 to process the audio signal sharing between the computing device 2, the mobile device 3, and the audio input/output device 4 connected to the audio sharing device 10, so as to allow the computing device 2 to receive the audio signals from the mobile device 3 and the audio input/output device 4 simultaneously, allow the mobile device 3 to receive the audio signals from the computing device 2 and the audio input/output device 4 simultaneously, and allow the audio input/output device 4 to receive the audio signals from the mobile device 3 and the computing device 2 simultaneously. That is, the microprocessor 106 controls the audio processing module 103 to process the audio signal sharing between each of the devices connected to the audio sharing device 10, so as to allow each of the devices to receive the audio signals from the remaining devices.

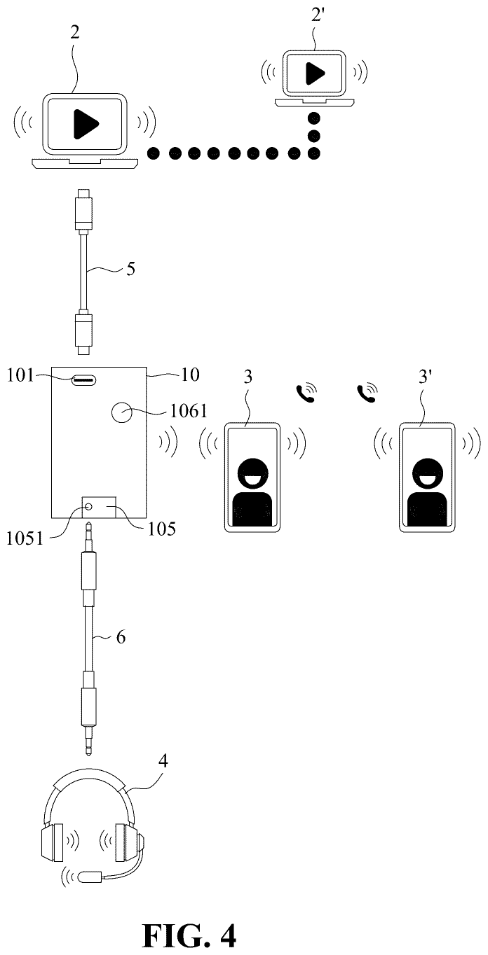

Referring to FIG. 4, FIG. 4 is a schematic view of a second application scenario of the audio sharing device 10 according to the first embodiment of the present invention. As shown in FIG. 4, the identical parts to FIG. 3 will be omitted. Another computing device 2′ performs wireless communication with the computing device 2, and another mobile device 3′ performs wireless communication with the mobile device 3. In this second application scenario, the video connection cable 5 may be a USB-C cable, the audio connection cable 6 may be a general 3.5 mm audio cable, the computing device 2 and 2′ may be laptops, the mobile device 3 and 3′ may be cellphones or tablets, the audio input/output device 4 may be a headset.

The audio sharing device 10 allows the computing device 2 (laptop), the mobile device 3 (cellphone), the audio input/output device 4 (headset), the computing device 2′ (another laptop) wirelessly connected to the computing device 2, and the mobile device 3′ (another cellphone) wirelessly connected to the mobile device 3 to share and transmit audio signals mutually.

Here, it should be understood that the first application scenario and the second application scenario is merely exemplary, and is also suitable for the audio sharing device 20 according the second embodiment of the present invention.

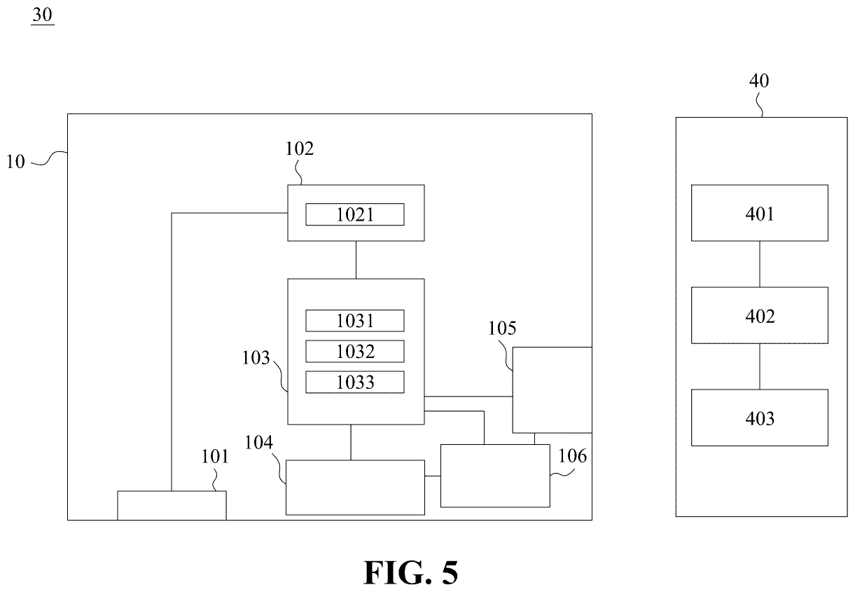

Referring to FIG. 5, FIG. 5 is a block diagram of an audio sharing system 30 according to the embodiment of the present invention.

The audio sharing system 30 according to the embodiments of the present invention comprises: the audio sharing device 10; and an electronic device 40.

Specifically, the electronic device 40 comprises: a processor 401 receiving audio signals from the audio sharing device 10 for performing an application; a memory 402 for storing audio signals; a storage unit 403 for storing the application; and a wireless module 404 for wirelessly connecting to the audio sharing device 10 to receive audio signals from the audio sharing device 10. The processor 401, the memory 402, the storage unit 403, and the wireless module 404 are connected to each other.

It is understandable that the audio sharing device comprised in the audio sharing system 30 may also be the audio sharing device 20 according to the second embodiment of the present invention.

The AI processing of the application performed on the audio signals comprises real-time AI functionalities such as real-time audio-to-text conversion, real-time audio translation, real-time speaker recognition, etc. Alternatively, the memory 402 may store the audio signals, such that after a whole audio signal segment is ended, the application stored in the storage unit 403 is used to perform non real-time AI functionalities such as audio summary, audio translation, etc. However, the present invention is not limited thereto. In addition, it should be understood that the application may perform the AI processing to audio signals by using the processor 401 or on the cloud.

It is understandable that the electronic device 40 may correspond to the mobile device 3 (e.g. a cellphone) connected to the audio sharing device 10 through wireless communication in the first application scenario. Additionally, the aforementioned application may be an APP (Application) installed on the mobile device 3. Alternatively, the electronic device 40 may be the computing device 2 (e.g. a laptop) connected to the audio sharing device 10 through the video connection cable 5 in the first application scenario. Additionally, the aforementioned application may be the app installed on the computing device 2. However, it is not limited thereto.

For example, when the electronic device 40 is the mobile device 3 connected to the audio sharing device 10 through wireless communication, the audio sharing system 30 may be connected to the computing device 2 through the video connection cable 5, and connected to the audio input/output device 4 through the audio connection cable 6, such that when a user performs a teleconference on the computing device 2 by the audio input/output device 4, the electronic device 40 connected to the audio sharing device 10 by wireless communication may receive the audio signals from the audio input/output device 4 and the computing device 2, and perform AI functionalities such as analyzing, recording, converting to text, translating on the audio signals.

In addition, on the outside of the audio sharing device 10, the audio sharing device 10 comprises the button unit 1061, the button unit 1061 is connected to the microprocessor 106 to allow a user to control the mode-switching of the audio sharing system 30 by the button unit 1061. Specifically, the audio sharing system 30 comprises at least two modes: a wireless mode in which the wireless module 104 is connected to the wireless module 404 of the electronic device 40 in a manner that enable the electronic device 40 to make a voice call; an AI mode in which the wireless module 104 is connected to the wireless module 404 of the electronic device 40 in a manner that enables the electronic device 40 to record voices such that the processor 401 of the electronic device 40 may use the application stored in the storage unit 403 to perform the aforementioned AI audio processing. However, it is not limited thereto, and the audio sharing system 30 may comprise any mode that allows a user to use the audio sharing system 30 conveniently.

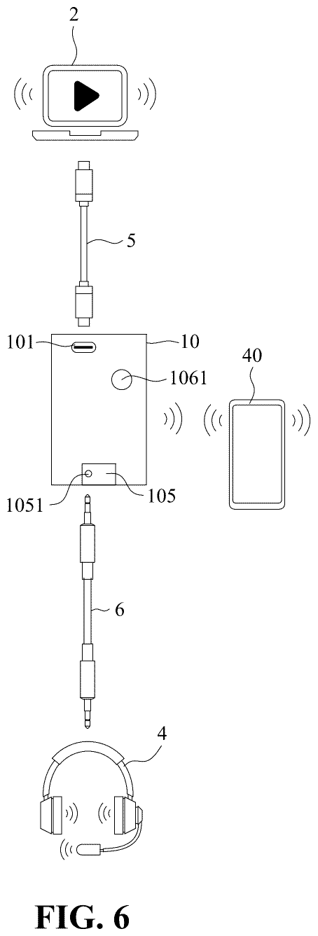

Referring to FIG. 6, FIG. 6 is a schematic view of an application scenario of the audio sharing system 30 according to the embodiments of the present invention. As shown in FIG. 6, the electronic device 40 may be implemented as a mobile device (e.g. a cellphone) connected to the audio sharing device 10 through the wireless module 404, and the electronic device 40 and the audio sharing device 10 are configured as the audio sharing system 30. The audio sharing device 10 of the audio sharing system 30 is connected to the computing device 2 through the video connection cable 5, and connected to the audio input/output device 4 through the audio connection cable 6. In this application scenario, the video connection cable 5 may be a USB-C cable to allow the computing device 2 to be connected to the audio sharing device 10 through the sharing port 101. The audio connection cable 6 may be a general 3.5 mm audio cable, and the audio input/output module 105 may include the audio cable port 1051 to allow the audio input/output device 4 to be connected to the audio sharing device 10 through the audio connection cable 6. In addition, the audio sharing device 10 may comprise a button unit 1061, the button unit 1061 is connected to the microprocessor 106 to allow a user to control the mode-switching of the audio sharing device 10 by the button unit 1061.

It is understandable that the APP is installed on the electronic device 40. The application may perform the AI processing to audio signals by using the processor 401 or on the cloud. The AI processing performed on the audio signals comprises real-time AI functionalities such as real-time audio-to-text conversion, real-time audio translation, real-time speaker recognition, etc. Alternatively, the memory 402 may store the audio signals, such that after a whole audio signal segment is ended, the application performs non real-time AI functionalities such as audio summary, audio translation, etc. However, the present invention is not limited thereto.

For example, when a user performs a teleconference on the computing device 2 by the audio input/output device 4, the audio sharing device 10 of the audio sharing system 30 may receive the audio signals from the audio input/output device 4 and the computing device 2, therefore, the electronic device 40 of the audio sharing system 30 may receive the audio signals from the audio input/output device 4 and the computing device 2 by the wireless modules 104 and 404, and perform AI functionalities such as analyzing, recording, converting to text, translating, etc., on the audio signals.

In view of the aforementioned, the audio sharing device of the present invention may allow multiple terminals (e.g. cellphones, tablets, computing devices) to share audio signals more effectively, and not only the audio sharing system of the present invention allows multiple terminals (e.g. cellphones, tablets, computing devices) to share the audio signals more effectively, but also the audio signals may be further processed.

The present invention is not limited to the aforementioned embodiments, and it is apparent to the person who has ordinary skills in the art that various modifications and variations can be made to the present invention without departing the spirit or scope of the present invention.

Therefore, the present invention covers the modifications and variation made to the present invention, or the modifications and variations that fall within the appended claims and its equivalent scope.

What is claimed is:

1. An audio sharing device, comprising:
a sharing port for receiving and transmitting audio signals;
a controlling portion connected to the sharing port, the controlling portion comprises a USB audio controller for converting and transmitting between audio signals and USB signals;
an audio processing module connected to the controlling portion and comprising a plurality of processing units for processing audio signals;
a wireless module connected to the audio processing module for wirelessly receiving and transmitting audio signals;
an audio input/output module connected to the audio processing module for playing and receiving audio signals; and
a microprocessor connected to the audio processing module, the audio input/output module and the wireless module for controlling the audio processing module to process an audio signal sharing of the audio sharing device.

2. The audio sharing device of claim 1,
wherein the sharing port is connected to a first electronic device to receive audio signals from the first electronic device and transmit audio signals to the first electronic device,
wherein the wireless module is wirelessly connected to a second electronic device to receive audio signals from the second electronic device and transmit audio signals to the second electronic device, and
wherein the audio input/output module is connected to an audio input/output device to receive audio signals from the audio input/output device and transmit audio signals to the audio input/output device.

3. The audio sharing device of claim 2, wherein the audio processing module comprises:
a first processing unit for receiving audio signals from the second electronic device via the wireless module and audio signals from the audio input/output device via the audio input/output module, and processing the audio signals to form a first channel audio signal;
a second processing unit for receiving audio signals from the first electronic device via the controlling portion and audio signals from the audio input/output device via the audio input/output module, and processing the audio signals to form a second channel audio signal; and
a third processing unit for receiving audio signals from the first electronic device via the controlling portion and audio signals from the second electronic device via the wireless module, and processing the audio signals to form a third channel audio signal.

4. The audio sharing device of claim 3,
wherein the first channel audio signal is transmitted to the first electronic device by the controlling portion and the sharing port,
wherein the second channel audio signal is transmitted to the second electronic device by the wireless module, and
wherein the third channel audio signal is transmitted to the audio input/output device by the audio input/output module.

5. The audio sharing device of claim 1, further comprising:
a power supply port for receiving power from a power source;
a power unit connected to the controlling portion and the sharing port for controlling the received power;
a USB connection port connected to the controlling portion for connecting to a USB device;
a memory card connection port connected to the controlling portion for writing audio signals into a memory card;
an internet connection port connected to the controlling portion for connecting to internet; and
a multifunctional controller in the controlling portion for controlling a hub function of the audio sharing device.

6. An audio sharing system, comprising:
the audio sharing device of claim 1; and
an electronic device, comprising:
a processor for performing an application;
a memory for storing audio signals;
a storage unit for storing the application; and
a wireless module for wirelessly connecting to the audio sharing device to receive audio signals from the audio sharing device,
wherein the application performs an AI processing on the audio signals by using the processor or on the cloud.

7. The audio sharing system of claim 6, wherein the AI processing comprises real-time AI functionalities such as real-time audio-to-text conversion, real-time audio translation, real-time speaker recognition, and non-real-time AI functionalities such as audio summary and audio translation.

8. The audio sharing system of claim 7, wherein the audio sharing device further comprises a button unit, the button unit is connected to the microprocessor to control a mode-switching of the audio sharing system.

9. The audio sharing system of claim 8, wherein controlling the audio sharing system comprises the following modes:
a wireless mode for allowing the wireless module of the audio sharing device to be connected to the wireless module of the electronic device in a manner that enable the electronic device to make a voice call; and
an AI mode for allowing the wireless module of the audio sharing device to be connected to the wireless module of the electronic device in a manner that enable the electronic device to record voices such that the application performs the AI audio processing by using the processor or on the cloud.
